(19) United States
(12) Patent Application Publication
(10) Pub. No.: US 2010/0124738 A1
(43) Pub. Date: May 20, 2010

(54) USER INTERFACE FOR INTERACTIVE TEACHING, AND METHOD FOR OPERATING THE SAME

(76) Inventors: Yuan Yuan, Tao-Yuan (TW); Shih-Ming Chang, Tao-Yuan (TW)

Correspondence Address: STOUT, UXA, BUYAN & MULLINS LLP, 4 VENTURE, SUITE 300, IRVINE, CA, 92618, US

(21) Appl. No.: 12/345,614

(22) Filed: Dec. 29, 2008

(30) Foreign Application Priority Data
Nov. 19, 2008 (TW) 097144741

(51) Int. Cl. G09B 19/00

(52) U.S. Cl. 434/365

(57) ABSTRACT

A user interface for interactive teaching is disclosed herein. The user interface for interactive teaching includes a tool section, a display section and a control section. The tool section is used to store several objects. The display section is used to display the objects, which are dragged by a mouse from the tool section. The control section includes a saving unit, a theme selecting unit and a loading unit. The theme selecting unit is used to facilitate the choosing of a theme, and the theme is operated in cooperation or conjunction with the objects to be a complete teaching project. The saving unit is used to save the teaching project, and the loading unit is able to load the teaching project.

### BACKGROUND OF THE INVENTION

1. Field of the Invention

The present invention is related to a user interface for interactive teaching, and method for operating the same, and more particularly related to a user interface for interactive teaching, which allows users to reuse and share teaching templates made by their own or other users.

2. Description of the Prior Art

Being in the digital age, in which conventional teaching methods typically are no longer able to satisfy users' requests, multiple forms of interactive teaching software are being released. Interactive teaching software can be defined as interactive teaching material aimed toward facilitating the learning of students by combining actual teaching material and computer technology. Interactive teaching software includes several advantages, such as not taking up space and ease of duplication, sharing, and organization, and overall is more convenient than conventional methods of implementing interactive teaching materials.

As technology improves day after day, internet development grows as well, at an extremely fast pace, and interactive teaching software must be updated to be or to be more suitably internet-based. Without having to install a program on a local computer, a user can utilize the interactive teaching software simply through use of the internet. This networking interactive teaching software has the benefit of long-distance teaching without the high cost. A user having only one internet-connected computer is able to use the interactive teaching software over the network.

However, most of today's user interfaces for interactive teaching on the internet are small applets designed for a specific teaching object. In other words, today's selection of user interface options for interactive teaching is extremely limited in that a user cannot make minor changes, for example, for different students.

Therefore, there is a need to design a new user interface for interactive teaching for the user, so as to allow for reuse and sharing of the teaching templates. The user should be able to design his or her own personal user interface for interactive teaching to increase the teaching efficiency.

### SUMMARY OF THE INVENTION

In view of the foregoing, one object of the present invention is to provide a user interface for interactive teaching that allows users to easily and quickly design their own teaching templates. Furthermore, according to an object, users can reuse and share the templates through the provided user interface with other users.

According to the above-mentioned and other objects, a user interface for interactive teaching is disclosed which includes a tool section, a display section and a control section. The tool section is used to provide a plurality of objects choosable by users. The display section is used to display the objects, which are dragged by a pointer device from the tool section. The control section includes a saving unit, a theme selecting unit and a loading unit. The theme selecting unit is used to choose or to facilitate choosing of a theme operated in cooperation or conjunction with the objects to be or form a template, the saving unit is used to save the template, and the loading unit is used to load the template.

According to the objects described above, an electronic system used for displaying a user interface is disclosed herein, which includes a display device and a user interface. The display device is used to display the user interface. The user interface includes a tool section, a display section and a control section. The tool section is used to provide a plurality of objects choosable by users. The display section is used to display the objects, which are dragged by a pointer device from the tool section. The control section includes a saving unit, a theme selecting unit and a loading unit. The theme selecting unit is used to choose a theme operated in cooperation or conjunction with the objects to be or form a template, the saving unit is used to save the template, and the loading unit is used to load the template.

According to the objects described above, an operating method in a user interface for interactive teaching is disclosed herein. First, a theme database is provided in the user interface with a plurality of themes choosable by users. Next, an object database is provided in the user interface with a plurality of choosable objects. Afterwards, the chosen objects and the chosen theme are displayed in the user interface, and then saved to be a dynamic web page file by the user interface. Finally, the dynamic web page file is loaded by the user interface or other web-compatible program.

### BRIEF DESCRIPTION OF THE DRAWINGS

The foregoing aspects and many of the advantages of this invention will become more readily appreciated as the same becomes better understood by reference to the following detailed description, when taken in conjunction with the accompanying drawings, wherein:

FIG. 1 is a view illustrating a user interface for interactive teaching.

FIG. 2 is a view illustrating the formation of the dynamic web page file.

FIG. 3A and FIG. 3B are views illustrating the function list of the teaching object.

FIG. 4 is a flowchart illustrating the operating method used in the user interface for interactive teaching.

FIG. 5 is a view illustrating the teaching project with accomplish design.

FIG. 6A is a view illustrating the template packaging interface in the user interface.

FIG. 6B is a view illustrating the teaching material made from FIG. 6A being loaded in the user interface.

### DESCRIPTION OF THE PREFERRED EMBODIMENT

The detailed description of the present invention will be discussed in the following embodiments, which are not intended to limit the scope of the present invention and can be adapted for other applications. While drawings are illustrated in details, it is appreciated that the quantity of the disclosed components may be greater or less than that disclosed, except expressly restricting the amount of the components.

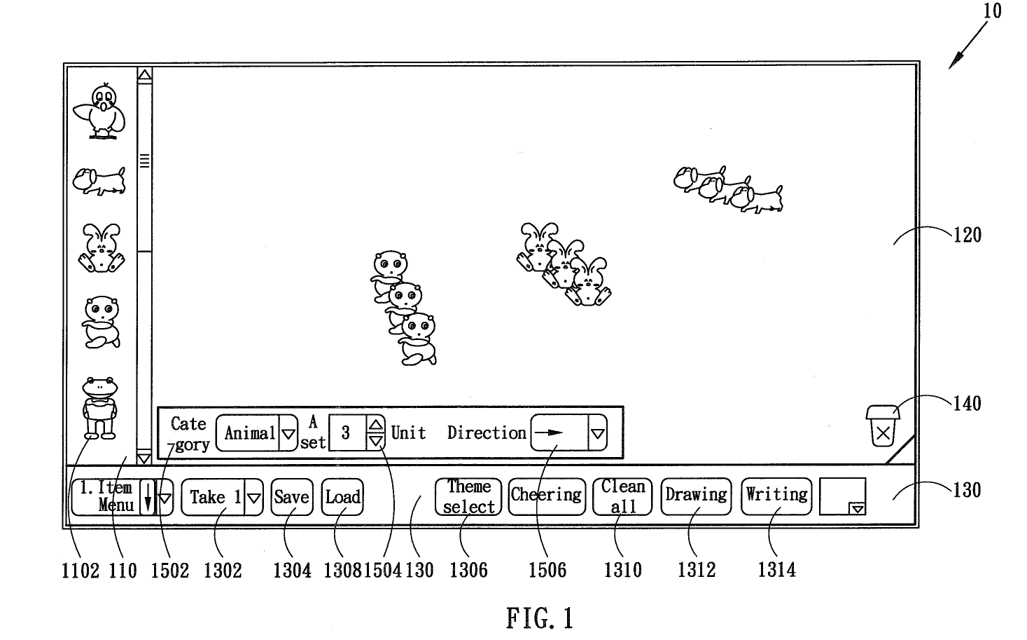

FIG. 1 illustrates a user interface for interactive teaching. As shown in FIG. 1, the user interface 10 includes a tool section 110, a display section 120 and a control section 130. Some common objects 1102 (such as rulers, scales, Cuisenaire rods and so on) are provided in the tool section 110 for the user to choose. These teaching objects 1102 can be dragged to the display section 120 by a pointer device (such as a computer mouse). The object's 1102 characteristics can be shown by clicking the button of the pointer device and the user can change the object's 1102 characteristics according to the different teaching subject or personal favorite. The control section 130 includes a group quantity setting unit 1302, a saving unit 1304, a theme selecting unit 1306, a loading unit 1308, and a clean all unit 1310. The group quantity setting unit 1302 is used to adjust the group quantity of the objects 1102 for dragging (e.g., by one dragging) by or of the pointer device in the display section 120, wherein the minimum object quantity for each group is one and the minimum group quantity is one. In another embodiment, the group quantity setting unit 1302 can also be placed in the tool section 110. In addition, the user interface 10 provides a variety of themes by the theme selecting unit 1306. The saving unit 1304 is used to store the chosen objects 1102 and the chosen theme as a teaching template (or template). The preferred file format of the template is a dynamic web page file. Therefore, the template, stored as a dynamic web page file, can be easily reused by different users to save time, set off or lead to a creative spark and/or generate fresh ideas. The loading unit 1308 is used to load the template.

Still referring to FIG. 1, the user interface for interactive teaching 10 further includes a trash can 140. The user can drag any unwanted objects 1102 in the trash can 140 by the pointer device, with the disposed objects being recoverable. In a different embodiment, the control section 130 further includes some additional units. For example, a drawing unit 1312 is used for or by users to draw something in the display section 120. A writing section 1314 is used for or by users to write something in the display section 120. The clean all unit 1310 is used to clean up the drawings and/or writings in the display section 120, so that the user saves time by not having to erase each individual drawing/writing when designing/editing a new template. Moreover, the objects 1102 can be divided into the dynamic objects 1102 (such as nail plates, scales and so on) and the static objects 1102 (such as animals, furniture and so on). The difference between the dynamic objects 1102 and the static teaching object 1102 is that the dynamic objects 1102 interact or show interaction with other objects 1102 or theme, while the static objects 1102 do not. For example, if the dynamic teaching object 1102 is a nail plate, the nail plate will show a different number of the measured area when the rubbers encircle each of the nails at each time. If the teaching object 1102 is a scale, the indicator of the scale will point to the different scale number when calculating the weight of the different teaching object 1102.

As shown in FIG. 1, the user interface 10 in this embodiment further includes an object classified unit 1502, an object quantity setting unit 1504, and an object direction unit 1506. The object classified unit 1502 is used to select the classified objects 1102 in a fast, efficient and organized way. For example, if the user would like to have a puppy be his teaching object 1102, the user can first choose an animal classification in the object classified unit 1502, and then the objects 1102 (such as puppy, cat/kitten, elephant and so on) are shown in the tool section 110. The user can choose the puppy in the tool section 110 and drag it to the display section 120. Moreover, the object quantity setting unit 1504 is used to adjust the quantity of the objects 1102 in each group. The object quantity setting unit 1504 can be used with the group quantity setting unit 1302. For example, when the user chooses three units of the objects 1102 in the object quantity setting unit 1504 and two units of the objects 1102 in the group quantity setting unit 1302, six objects are generated in the display section 120 by dragging (e.g., by one dragging) from the tool section 110. The object direction unit 1506 is used to adjust the arrangement direction of the objects 1102 in each group (such as vertical direction, horizontal direction, sloping direction and so on). It should be noted that the object classified unit 1502, the object quantity setting unit 1504 and the object direction unit 1506 can be disposed at the display section 120 as shown in FIG. 1, or placed on the tool section 110 or the control section 130. In addition, the control section 130 can be located anywhere in the user interface 10, such as the top or bottom of the display section 120, and it is not limited herein.

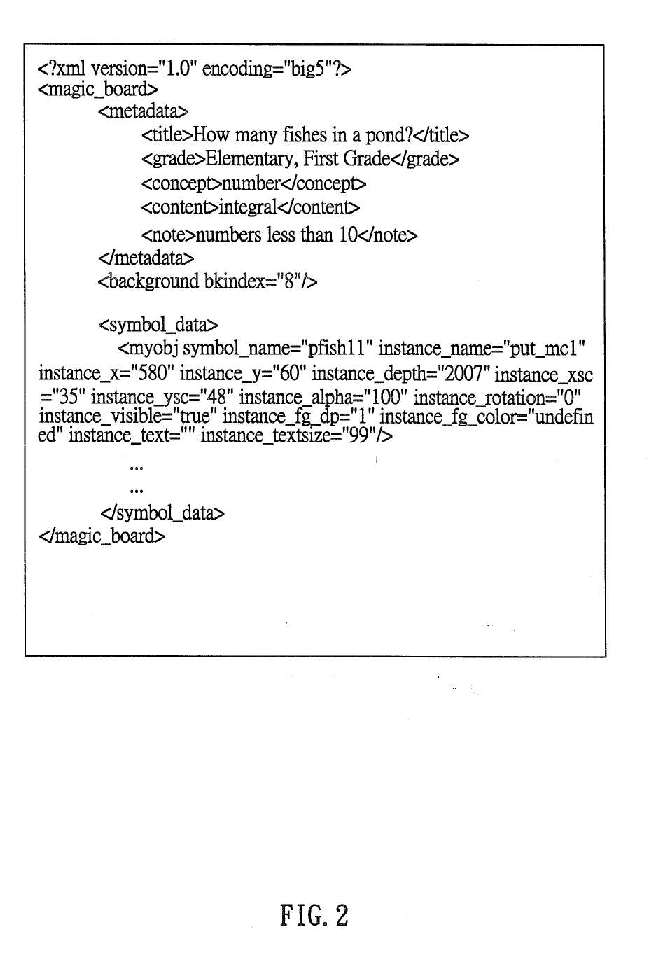

FIG. 2 shows an example of the dynamic web page file. For the purpose of allowing other users (such as other teachers) to easily use the template, a dynamic web page file is a preferred file format for the template, such as Extensible Markup Language (XML) file or Cascade Style Sheet (CSS) file. FIG. 2 is an embodiment of the dynamic web page file saved in XML format. In different embodiments, the dynamic web page file can be saved in another format and is not limited to that disclosed herein. As shown in FIG. 2, the XML file includes title, grade, content, and so on. Furthermore, the characteristics of the teaching object 1102 are also saved in the dynamic web page file, such as weight, circumference, rotation angle and so on. In addition, it should be noted that the characteristic of the objects 1102 still can be changed when the user loads the dynamic web page file by the loading unit 1308 and uses the template in the display section 130. In this way, the teaching activity can be made and become more interactive and flexible.

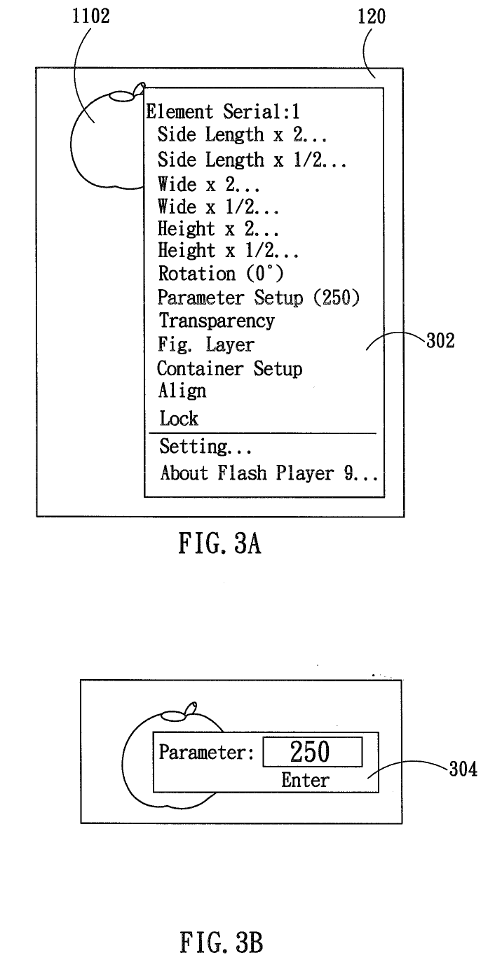

FIG. 3A and FIG. 3B show the function list with different characteristics of the teaching object 1102. As shown in FIG. 3A, after a teaching object 1102 is dragged to the display section 120, the user can choose, via clicking the button of the pointer device to show the function list, the characteristic 302 of the object 1102, such as length, width, height, rotation angle, transparency, measured area, capacity, and volume. For example, when the user chooses a teaching object 1102 (e.g., apple) and drags it to the display section 120, the user clicks the button (e.g., right button) of the pointer device to show the function list to set the characteristic (such as apple's weight) of the object 1102. In a different embodiment, the teaching object 1102 is a dynamic teaching object 1102 (such as clock, scales, ruler and so on). The button of the pointer device is able to help the user to change the “units” of the objects 1102 (for example, showing the second hand, the minute hand and the hour hand on a clock, or simply showing the hour hand on a clock). When a specific characteristic 302 of the object 1102 is chosen in the characteristic list, the windows open in FIG. 3 for the user to input the reference number 304 of the characteristic 302 of the object 1102.

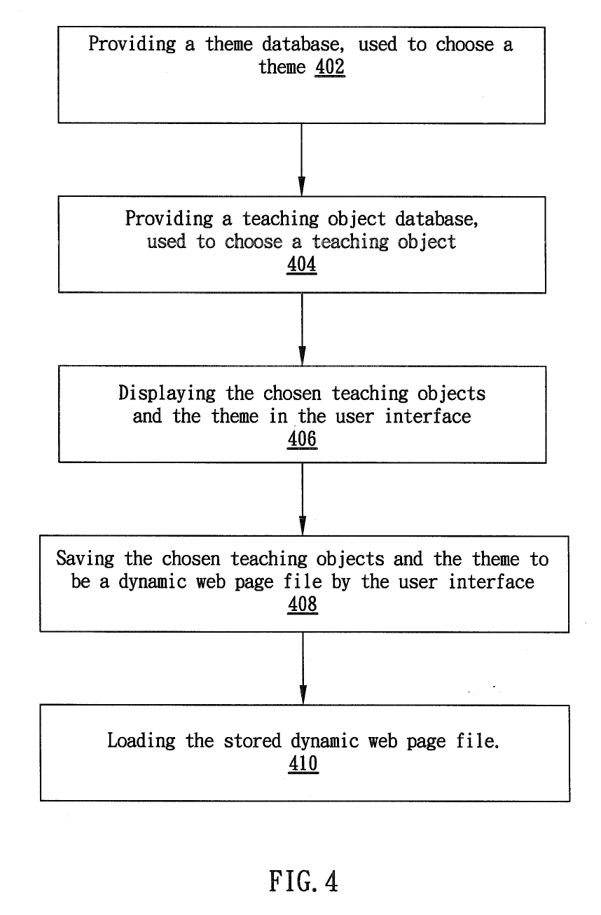

FIG. 4 is a flowchart showing the operating method in a user interface for interactive teaching. The operating method includes the following steps. In step 402, a theme database is provided with a plurality of themes for a user to choose. The user can use the theme selecting unit 1306 to choose a theme from the theme database, and the theme will be shown in the display section of the user interface. In step 404, a teaching object database is provided with a plurality of objects for the user to choose. The user is able to choose a teaching object 1102 from the tool section 120. In step 406, the chosen objects 1102 and the chosen theme are displayed in the user interface, and then saved as a template (dynamic web page file is the preferred format) via the user interface in step 408. In step 410, the template is loaded on the user interface. In a preferred embodiment, before the template is saved, the function list of the teaching object is shown in the user interface and allows the user to set specific characteristics/parameters. In another preferred embodiment, before the dynamic web page is saved, the function list of the theme is shown in the user interface and allows the user to set specific characteristics/parameters. An example wherein both the objects and themes are with specific characteristics/parameters is a template of the decimal system. There are several columns on a specific theme (units, tens, hundreds and so on), and each column can show the quantity of the objects dragged into the column. The specific object (e.g., Dynamic Cuisenaire rods) can be dragged into the column (e.g., units), and when the quantity of rods reaches 10, the rods would arrange in a row or specific arrangement and form a “bigger object”; then, the user can drag the “bigger object” to the next column (e.g., tens), so as to show the base-ten concept.

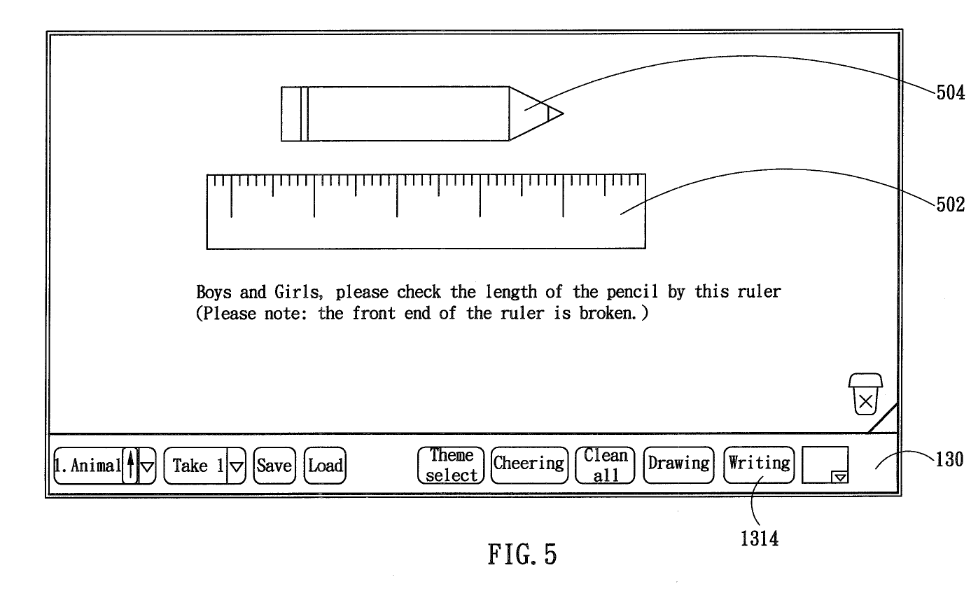

For a further understanding of the user interface according to the present invention, FIG. 5 illustrates a preferred template design for students to learn, for example, how to use a ruler to determine the length of a pencil. In the user interface 10, the pointer device is used to drag the objects (a ruler 502 and a pencil 504) from the tool section 110 to the display section 120. The fraction marks of the ruler 502 and the length of the pencil 503 are set by using the function list as described above. Then, one fraction mark (e.g., Zero) of the ruler 502 is placed at one end of the pencil 503, usually on the left side, allowing students to practice how to use or measure with a ruler. In addition, the writing unit 1314 of the control section 130 is used to input hints or notes so that the template is more interactive and easy to use.

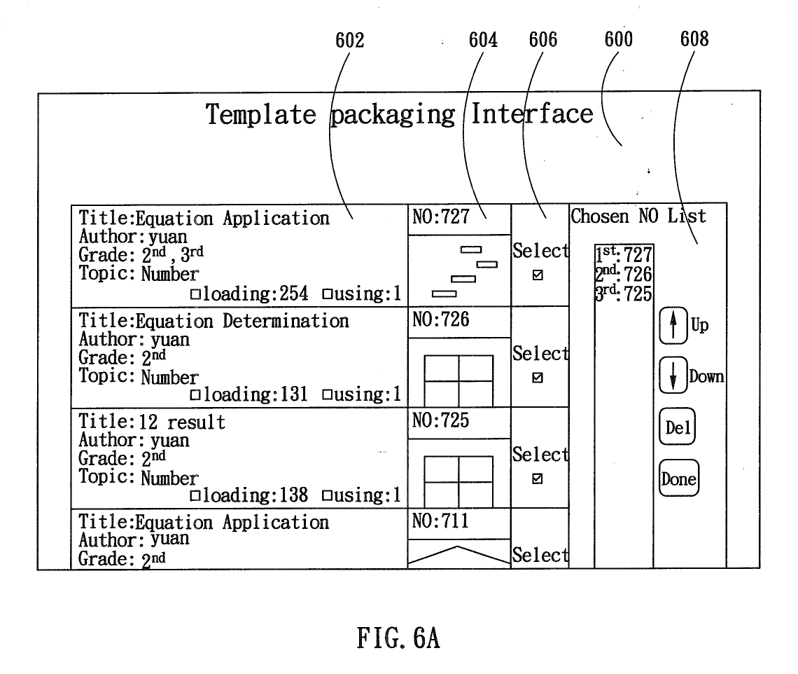

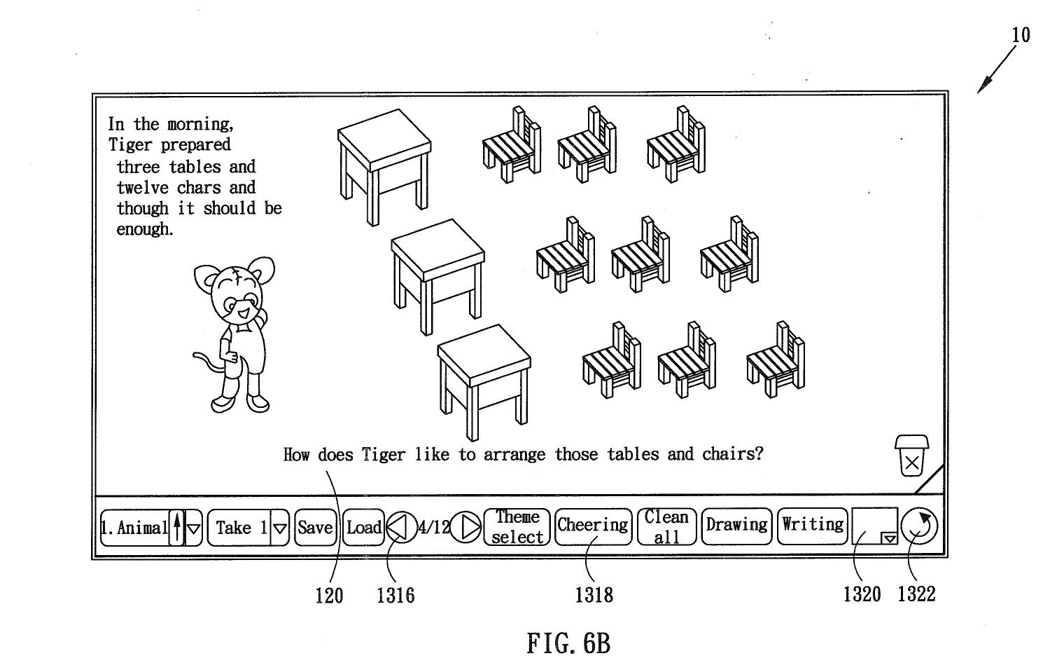

As shown in FIG. 6A, after the user designed and saved the template in the user interface, the template packaging interface 60 is used to select and combine at least one template to form a teaching material, and the teaching material is a dynamic web page file. The template packaging interface 60 includes a template description block 602, a serial number and mini-figure block 604, a choosing button 606, and a template selecting block 608. The template description block 602 is used to give a brief introduction of the template. The serial number and mini-figure block 604 is used so that the user can understand the layout of the template. The choosing button 606 is used to allow the user to choose the desired templates, and the template selecting block 608 is used to save the chosen templates as a signal file (such as a dynamic web page file format).

FIG. 6B illustrates the teaching material made from FIG. 6A being loaded in the user interface. As shown in FIG. 6B, the control section further includes a page selecting unit to choose the previous/next page of the teaching material. Besides, in a different embodiment the user interface 10 further includes an audio output unit 1318, a color unit 1320 and a reset unit 1322. The audio output unit 1318 is used to enable a computer or an electronic device to play pre-stored audio data, so as to encourage the students. The color unit 1320 is used to change the color of the objects and/or the color of the writing words to increase the variability of the user interface 10. The control section further includes a reset unit 1322, which is used to restore the objects to their original position as in the dynamic web page file.

Moreover, it should be noted that the user interface for interactive teaching 10 can be displayed by a regular browser, such as Microsoft Internet Explorer or Mozilla Firefox, and can be displayed by a normal player (such as Flash player or Java player). In other words, besides a desktop or laptop computer, any suitable electronic device can run the browser or player described above to show the user interface in the display device of the electronic device. The display device can be an LCD panel, LED panel, projector or CRT apparatus. Any display device or devices that can be used in the electronic device or devices are intended to be included in the embodiments of the present invention. Therefore, the browser or player can run the user interface for interactive teaching 10 when an internet connection is available.

Although specific embodiments have been illustrated and described, it will be appreciated by those skilled in the art that various modifications may be made without departing from the scope and spirit of the present invention, which is intended to be limited solely by the appended claims.

What is claimed is:

1. A user interface for interactive teaching, comprising:
a tool section used to provide a plurality of objects for users to choose;
a display section used to display said objects, which are dragged by a pointer device from said tool section; and
a control section including a saving unit, a theme selecting unit and a loading unit, said theme selecting unit being used to choose a theme operated in cooperation with said objects to be a template, said saving unit being used to save said template and said loading unit being used to load said template.

2. The user interface of claim 1, wherein said control section further comprises a group quantity setting unit, which is used to adjust the group quantity of said objects for dragging by said pointer device in said display section, wherein the minimum object quantity for each group is one and the minimum group quantity is one.

3. The user interface of claim 1, wherein said tool section further comprises a group quantity setting unit, which is used to adjust the group quantity of said objects for dragging by said pointer device in said display section, wherein the minimum object quantity for each group is one and the minimum group quantity is one.

4. The user interface of claim 1, wherein said control section further comprises a drawing unit, which is used to draw in said display section by said pointer device.

5. The user interface of claim 1, wherein said control section further comprises a writing unit, which is used to input a plurality of words in said display section by way of a keyboard.

6. The user interface of claim 5, wherein said user interface further comprises a color unit, which is used to change colors of said words written by said writing unit.

7. The user interface of claim 1, wherein said user interface further comprises a trash can in said display section for facilitating disposal of unwanted objects, and wherein the disposed objects are recoverable.

8. The user interface of claim 1, wherein said user interface further comprises a template packaging interface to facilitate selecting and combining of at least one template to form a teaching material, and wherein the teaching material is a dynamic web page file.

9. The user interface of claim 8, wherein said control section further includes a page selecting unit to facilitate choosing of a previous and/or next page of said teaching material.

10. The user interface of claim 1, wherein each of said objects includes a plurality of characteristics, and each of said characteristics can be adjusted by changing a parameter of said teaching object, wherein said characteristics of said objects include: weight, height, rotation angle, transparency, measure area, capacity and volume.

11. The user interface of claim 1, wherein said control section further includes an audio output unit, which is used to enable a computer or an electronic device to play pre-stored audio data.

12. The user interface of claim 8, wherein said control section further includes a reset unit, which is used to restore said objects to their original position as in said dynamic web page file.

13. The user interface of claim 2, wherein said user interface further includes:
an object classified unit used to select the classified objects;
an object quantity setting unit used to adjust the quantity of said objects of each group; and
an object direction unit used to adjust the direction of said objects of each group.

14. An electronic system used for displaying a user interface, comprising:
a display device used to display said user interface; and
said user interface comprising:
a tool section used to provide a plurality of objects choosable by a user;
a display section used to display said objects, which are dragged by a pointer device from said tool section; and
a control section including a saving unit, a theme selecting unit and a loading unit, said theme selecting unit being used to facilitate choosing of a theme operated in cooperation with said objects to be a template, said saving unit being used to save said template and said loading unit being used to load said template.

15. The electronic device of claim 14, wherein said display device is selected from the group consisting of LCD panel, LED panel, projector and CRT apparatus.

16. The electronic device of claim 14, wherein said control section further comprises a group quantity setting unit, which is used to adjust the group quantity of said objects for dragging by said pointer device in said display section, and wherein the minimum object quantity for each group is one and the minimum group quantity is one.

17. The electronic device of claim 14, wherein said tool section further comprises a group quantity setting unit, which is used to adjust the group quantity of said objects for dragging by said pointer device in said display section, and wherein the minimum object quantity for each group is one and the minimum group quantity is one.

18. The electronic device of claim 14, wherein said control section further comprises a drawing unit, which is used to draw in said display section by said pointer device.

19. The electronic device of claim 14, wherein said control section further comprises a writing unit, which is used to input a plurality of words in said display section via a keyboard.

20. The electronic device of claim 14, wherein said user interface further comprises a trash can in said display section for facilitating disposal of unwanted objects, and wherein the disposed objects are recoverable.

21. The electronic device of claim 14, wherein said user interface further comprises a template packaging interface to facilitate selecting and combining of at least one template to form a teaching material, and wherein the teaching material is a dynamic web page file.

22. The electronic device of claim 21, wherein said control section further includes a page selecting unit to facilitate choosing of one or more of a previous page and a next page of said teaching material.

23. The electronic device of claim 14, wherein each of said objects includes a plurality of characteristics, and each of said characteristics can be altered by changing a parameter of said teaching object, wherein said characteristics of said objects includes: weight, height, rotation angle, transparency, measure area, capacity and volume.

24. An operating method in a user interface for interactive teaching, comprising:
providing a theme database in said user interface with a plurality of themes choosable by a user;
providing an object database in said user interface with a plurality of objects choosable by a user;
displaying said chosen objects and said chosen theme in said user interface;
saving said chosen objects and said chosen theme as a dynamic web page file by said user interface; and
loading said stored dynamic web page file by said user interface.

25. The operating method of claim 24, further comprising showing a function list of said object to adjust at least one parameter of said object and saving said object with a characteristic before saving said dynamic web page file.

26. The operating method of claim 24, further comprising showing a function list of said theme to adjust at least one parameter of said theme and saving said theme with a characteristic before saving said dynamic web page file.

27. A computer program product with program code executable on a computer or electronic device to facilitate performance of the operating method of claim 24.

28. The computer program product of claim 27, comprising a storage, which holds the program code and which can be read by the computer or electronic device.
